(19) United States
(12) Patent Application Publication
(10) Pub. No.: US 2017/0329903 A1
(43) Pub. Date: Nov. 16, 2017

(54) PROVIDING OPERATION INSTRUCTION INFORMATION OF MEDICAL APPARATUS

(71) Applicant: Shenyang Neusoft Medical Systems Co., Ltd., Shenyang (CN)

(72) Inventors: Qingxiang SHU, Shenyang (CN); Qinghe SONG, Shenyang (CN)

(21) Appl. No.: 15/592,853

(22) Filed: May 11, 2017

(30) Foreign Application Priority Data
May 11, 2016 (CN) 201610311809.5

(51) Int. Cl. G06F 19/00; G06F 17/30; H04L 29/08

(52) U.S. Cl. CPC G06F 19/321; G06F 19/322; G06F 17/30483; G06F 17/30598; H04L 67/10

(57) ABSTRACT

Methods, devices, and systems for providing operation instruction information of medical apparatuses are provided. An example method includes obtaining current user operation information of a medical apparatus by a cloud server configured to communicate with a plurality of medical apparatuses having a same apparatus type as the medical apparatus, acquiring, based on the obtained current user operation information, target operation instruction information from an operation instruction information database associated with the plurality of medical apparatuses, and transmitting the target operation instruction information to the medical apparatus.

### CROSS REFERENCE TO RELATED APPLICATIONS

This application claims priority under 35 U.S.C. §119 to Chinese Patent Application No. 201610311809.5, filed on May 11, 2016, the entire content of which is incorporated herein by reference.

### TECHNICAL FIELD

The present disclosure relates to medical imaging diagnostics, particularly for providing operation instruction information of a medical apparatus.

### BACKGROUND

With the development of science and technology, the role of a medical apparatus in the diagnosis of diseases is becoming more and more important. The large-scale medical apparatus is generally equipped with a software operating system, which is operated by an operator to control the medical apparatus to scan an object (e.g., a patient) for helping doctors diagnose diseases of the object.

However, although software operating systems and hardware can be the same for medical apparatuses of a same type that are widely distributed all over the country and even around the world, due to different experiences and knowledge of different operators, scanning results can be different when different operators operate the same type of medical apparatus to scan a same region of interest of the object. Thus, accuracies of disease diagnosis results acquired based on the scanning results are different, which may not effectively improve the medical level and accordingly the medical apparatus may not effectively serve human health.

NEUSOFT MEDICAL SYSTEMS CO., LTD. (NMS), founded in 1998 with its world headquarters in China, is a leading supplier of medical equipment, medical IT solutions, and healthcare services. NMS supplies medical equipment with a wide portfolio, including CT, Magnetic Resonance Imaging (MRI), digital X-ray machine, ultrasound, Positron Emission Tomography (PET), Linear Accelerator (LINAC), and biochemistry analyser. Currently, NMS′ products are exported to over 60 countries and regions around the globe, serving more than 5,000 renowned customers. NMS's latest successful developments, such as 128 Multi-Slice CT Scanner System, Superconducting MRI, LINAC, and PET products, have led China to become a global high-end medical equipment producer. As an integrated supplier with extensive experience in large medical equipment, NMS has been committed to the study of avoiding secondary potential harm caused by excessive X-ray irradiation to the subject during the CT scanning process.

### SUMMARY

The present disclosure provides methods and devices for providing operation instruction information of a medical apparatus which can effectively instruct operators at different medical levels to operate the medical apparatus accurately, so that the medical apparatus can output a scanning result with higher quality to assist doctors in accurately diagnosing diseases. In such a way, the medical apparatus can serve human health better.

One aspect of the present disclosure features a method of providing operation instruction information of a medical apparatus by a cloud server configured to communicate with a plurality of medical apparatuses having a same apparatus type as the medical apparatus, the method including: obtaining, by one or more computing devices at the cloud server, current user operation information of the medical apparatus; acquiring, by the one or more computing devices at the cloud server and based on the obtained current user operation information, target operation instruction information from an operation instruction information database associated with the plurality of medical apparatuses; and transmitting, from the one or more computing devices at the cloud server, the target operation instruction information to the medical apparatus.

The method can further include establishing, by the one or more computing devices at the cloud server, the operation instruction information database based on history operation records of the plurality of medical apparatuses of the same apparatus type in different medical institutions. In some implementations, establishing the operation instruction information database includes: collecting the history operation records of the plurality of medical apparatuses of the same apparatus type; acquiring valid data in the collected history operation records to establish a valid database; and performing data mining and analysis on data in the valid database to establish the operation instruction information database for the plurality of medical apparatuses of the same apparatus type. Performing data mining and analysis on data in the valid database can include performing at least one of correlation analysis, sequence pattern analysis, or classification analysis on the data in the valid database.

Acquiring target operation instruction information from an operation instruction information database can include searching the target operation instruction information in the operation instruction information database based on an operation pattern of the medical apparatus, the operation instruction information database including respective operation instruction information associated with operation patterns of the medical apparatus.

In some implementations, transmitting the target operation instruction information to the medical apparatus includes at least one of: transmitting the target operation instruction information to the medical apparatus when a deviation between a current setting parameter in the current user operation information and a standard setting parameter in the target operation instruction information exceeds a predetermined range; transmitting the target operation instruction information to the medical apparatus when the current user operation information comprises help information; or transmitting the target operation instruction information to the medical apparatus when a current apparatus state parameter in the current user operation information exceeds a threshold in the target operation instruction information.

The method can further include obtaining, by the one or more computing devices at the cloud server, a current operation record of the medical apparatus; and updating, by the one or more computing devices at the cloud server, the target operation instruction information according to the obtained current operation record of the medical apparatus. The current user operation information of the medical apparatus can include at least one of: system setting operation information for processes of the medical apparatus, or scanning operation information for acquiring scanned images by the medical apparatus. The medical apparatus can include a computed tomography apparatus, a positron emission tomography apparatus, a magnetic resonance imaging apparatus, or an ultrasound imaging apparatus.

Another aspect of the present disclosure features a method performed by a medical apparatus, including: transmitting current user operation information of the medical apparatus to a cloud server configured to communicate with a plurality of medical apparatuses having a same apparatus type as the medical apparatus; receiving target operation instruction information from the cloud server, the target operation instruction information being acquired from an operation instruction information database according to the current user operation information by the cloud server, the operation instruction information database being associated with the plurality of medical apparatuses; and generating prompt information according to the target operation instruction information to prompt a user to operate the medical apparatus in accordance with the target operation instruction information.

In some implementations, generating prompt information according to the target operation instruction information includes at least one of: generating the prompt information according to the target operation instruction information when a deviation between a current setting parameter in the current user operation information and a standard setting parameter in the target operation instruction information exceeds a predetermined range; generating the prompt information according to the target operation instruction information when the current user operation information comprises help information; or generating the prompt information according to the target operation instruction information when a current apparatus state parameter in the current user operation information exceeds a threshold in the target operation instruction information.

The method can further include generating a current operation record according to a current operation result and a new current user operation information based on the target operation instruction information; and transmitting the generated current operation record to the cloud server to allow the cloud server to update the target operation instruction information for the medical apparatus according to the current operation record. Generating prompt information according to the target operation instruction information to prompt a user to operate the medical apparatus can include displaying, on a display of the medical apparatus, the generated prompt information to the user for operating the medical apparatus in accordance with the target operation instruction information.

In some implementations, the method further includes adjusting, by the medical apparatus and based on the target operation instruction information, one or more settings of the medical apparatus to operate the medical apparatus. The method can further include controlling the medical apparatus to scan a region of interest of an object based on the adjusted settings of the medical apparatus.

In some implementations, the method includes generating the current user operation information of the medical apparatus. Generating the current user operation information can include at least one of generating system setting operation information during processes of the medical apparatus, or generating scanning operation information during acquiring scanned images by the medical apparatus.

The operation instruction information database can include respective target operation instruction information associated with operation patterns of the medical apparatus. The medical apparatus can include a computed tomography apparatus, a positron emission tomography apparatus, a magnetic resonance imaging apparatus, or an ultrasound imaging apparatus.

A third aspect of the present disclosure features a system, including: one or more processors; and a non-transitory computer readable storage medium in data communication with the one or more processors and storing instructions executable by the one or more processors and upon such execution cause the one or more processors to perform a method of providing operation instruction information of a medical apparatus, the method comprising: obtaining current user operation information of the medical apparatus; acquiring, based on the obtained current user operation information, target operation instruction information from an operation instruction information database associated with a plurality of medical apparatuses having a same apparatus type as the medical apparatus; and transmitting the target operation instruction information to the medical apparatus.

A fourth aspect of the present disclosure features a method of controlling operation of a medical apparatus based on operation instruction information of the medical apparatus by a cloud server configured to communicate with a plurality of medical apparatuses having a same apparatus type as the medical apparatus, the method including: obtaining, by one or more computing devices at the cloud server, current user operation information of the medical apparatus; acquiring, by the one or more computing devices at the cloud server and based on the obtained current user operation information, target operation instruction information from an operation instruction information database associated with the plurality of medical apparatuses; and transmitting, from the one or more computing devices at the cloud server, one or more machine instructions based on the target operation instruction information to control the operation of the medical apparatus.

The method can further include establishing, by the one or more computing devices at the cloud server, the operation instruction information database based on respective history operation records of the plurality of medical apparatuses of the same apparatus type in different medical institutions. In some implementations, establishing the operation instruction information database includes: collecting the history operation records of the plurality of medical apparatuses of the same apparatus type; acquiring valid data in the collected history operation records to establish a valid database; and performing data mining and analysis on data in the valid database to establish the operation instruction information database for the plurality of medical apparatuses of the same apparatus type. Performing data mining and analysis on data in the valid database can include performing at least one of correlation analysis, sequence pattern analysis, or classification analysis on the data in the valid database.

Acquiring target operation instruction information from an operation instruction information database can include searching the target operation instruction information in the operation instruction information database based on an operation pattern of the medical apparatus, the operation instruction information database including respective target operation instruction information associated with operation patterns of the medical apparatus.

In some implementations, the method includes at least one of: generating the machine instructions based on the target operation instruction information to control the operation of the medical apparatus when a deviation between a current setting parameter in the current user operation information and a standard setting parameter in the target operation instruction information exceeds a predetermined range; generating the machine instructions based on the target operation instruction information to control the operation of the medical apparatus when the current user operation information comprises help information; or generating the machine instructions based on the target operation instruction information to control the operation of the medical apparatus when a current apparatus state parameter in the current user operation information exceeds a threshold in the target operation instruction information.

In some implementations, the method includes at least one of: transmitting the target operation instruction information to the medical apparatus when a deviation between a current setting parameter in the current user operation information and a standard setting parameter in the target operation instruction information exceeds a predetermined range; transmitting the target operation instruction information to the medical apparatus when the current user operation information comprises help information; or transmitting the target operation instruction information to the medical apparatus when a current apparatus state parameter in the current user operation information exceeds a threshold in the target operation instruction information.

The method can further include obtaining, by the one or more computing devices at the cloud server, a current operation record of the medical apparatus; and updating, by the one or more computing devices at the cloud server, the target operation instruction information according to the obtained current operation record of the medical apparatus.

The current user operation information of the medical apparatus comprises at least one of: system setting operation information generated during processes of the medical apparatus, or scanning operation information generated during acquiring scanned images by the medical apparatus. The medical apparatus can include a computed tomography apparatus, a positron emission tomography apparatus, a magnetic resonance imaging apparatus, or an ultrasound imaging apparatus.

A fifth aspect of the present disclosure features a method of operating a medical apparatus, including: transmitting current user operation information of the medical apparatus to a cloud server configured to communicate with a plurality of medical apparatuses having a same apparatus type as the medical apparatus; receiving target operation instruction information from the cloud server, the target operation instruction information being acquired from an operation instruction information database according to the current user operation information by the cloud server, the operation instruction information database being associated with the plurality of medical apparatuses; and adjusting, by the medical apparatus and based on the target operation instruction information, one or more settings of the medical apparatus to operate the medical apparatus. The method can further include controlling the medical apparatus to scan a region of interest of an object based on the adjusted settings of the medical apparatus.

In some implementations, adjusting one or more settings of the medical apparatus includes at least one of: adjusting the one or more settings according to the target operation instruction information when a deviation between a current setting parameter in the current user operation information and a standard setting parameter in the target operation instruction information exceeds a predetermined range; adjusting the one or more settings according to the target operation instruction information when the current user operation information comprises help information; or adjusting the one or more settings according to the target operation instruction information when a current apparatus state parameter in the current user operation information exceeds a threshold in the target operation instruction information.

In some implementations, the method includes generating, by the medical apparatus, prompt information according to the target operation instruction information; and displaying the generated prompt information to a user for operation of the medical apparatus in accordance with the target operation instruction information. Generating prompt information according to the target operation instruction information can include at least one of: generating the prompt information according to the target operation instruction information when a deviation between a current setting parameter in the current user operation information and a standard setting parameter in the target operation instruction information exceeds a predetermined range; generating the prompt information according to the target operation instruction information when the current user operation information comprises help information; or generating the prompt information according to the target operation instruction information when a current apparatus state parameter in the current user operation information exceeds a threshold in the target operation instruction information.

The method can further include generating a current operation record according to a current operation result and a new current user operation information based on the target operation instruction information; and transmitting the generated current operation record to the cloud server to make the cloud server update the target operation instruction information for the medical apparatus according to the current operation record. The method can further include generating the current user operation information of the medical apparatus by generating at least one of: system setting operation information generated during processes of the medical apparatus, or scanning operation information generated during acquiring scanned images by the medical apparatus.

The operation instruction information database can include respective target operation instruction information associated with operation patterns of the medical apparatus. The medical apparatus can include a computed tomography apparatus, a positron emission tomography apparatus, a magnetic resonance imaging apparatus, or an ultrasound imaging apparatus.

A sixth aspect of the present disclosure features a system, including: one or more processors; and a non-transitory computer readable storage medium in data communication with the one or more processors and storing instructions executable by the one or more processors and upon such execution cause the one or more processors to perform operations including: transmitting current user operation information of the medical apparatus to a cloud server configured to communicate with a plurality of medical apparatuses having a same apparatus type as the medical apparatus; receiving target operation instruction information from the cloud server, the target operation instruction information being acquired from an operation instruction information database according to the current user operation information by the cloud server, the operation instruction information database being associated with the plurality of medical apparatuses; and adjusting, by the medical apparatus and based on the target operation instruction information, one or more settings of the medical apparatus to operate the medical apparatus.

Other embodiments of these aspects include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The terms used in the present disclosure are for the purpose of describing particular embodiments only and are not intended to be limiting of the present disclosure. The singular form such as “a” and “the” used in the present disclosure and the claims is intended to include the plural form as well, unless stated clearly otherwise in the context. It is also to be understood that the terms such as “and/or” used herein refer to and encompass any or all possible combinations of one or more of the associated listed items.

The details of one or more embodiments of the subject matter described in the present disclosure are set forth in the accompanying drawings and description below. Other features, aspects, and advantages of the subject matter will become apparent from the description, the drawings, and the claims.

### BRIEF DESCRIPTION OF DRAWINGS

FIG. 1 is a schematic diagram of an application scenario of providing operation instruction information of a medical apparatus in accordance with one or more examples of the present disclosure.

FIG. 2 is a flow diagram of a process of providing operation instruction information of a medical apparatus in accordance with one or more examples of the present disclosure.

FIG. 3 is a flow diagram of a process of providing operation instruction information of a medical apparatus in accordance with one or more another examples of the present disclosure.

FIG. 4 is a flow diagram of a process of generating an operation instruction information database of medical apparatuses of a same type in accordance with one or more examples of the present disclosure.

FIG. 5 is a flow diagram of a process of providing operation instruction information of a medical apparatus in accordance with one or more another examples of the present disclosure.

FIG. 6 is a flow diagram of a process of obtaining operation instruction information of a medical apparatus in accordance with one or more another examples of the present disclosure.

FIG. 7 is a flow diagram of a process of obtaining operation instruction information of a medical apparatus in accordance with one or more another examples of the present disclosure.

FIG. 8 is a block diagram of a device for providing operation instruction information of a medical apparatus in accordance with one or more examples of the present disclosure.

FIG. 9 is a block diagram of a device for providing operation instruction information of a medical apparatus in accordance with one or more another examples of the present disclosure.

FIG. 10 is a block diagram of an instruction information database acquiring module of the device in FIG. 9 in accordance with one or more examples of the present disclosure.

FIG. 11 is a block diagram of a transmitting module of the device in FIG. 8 in accordance with one or more examples of the present disclosure.

FIG. 12 is a block diagram of a device for providing operation instruction information of a medical apparatus in accordance with in accordance with one or more another examples of the present disclosure.

FIG. 13 is a block diagram of a device for providing operation instruction information of a medical apparatus in accordance with one or more another examples of the present disclosure.

FIG. 14 is a block diagram of an information prompting module of the device in FIG. 13 in accordance with one or more examples of the present disclosure.

FIG. 15 is a block diagram of a device for providing operation instruction information of a medical apparatus in accordance with one or more another examples of the present disclosure.

FIG. 16 is a structural diagram of a device for providing operation instruction information of a medical apparatus in accordance with one or more examples of the present disclosure.

### DETAILED DESCRIPTION

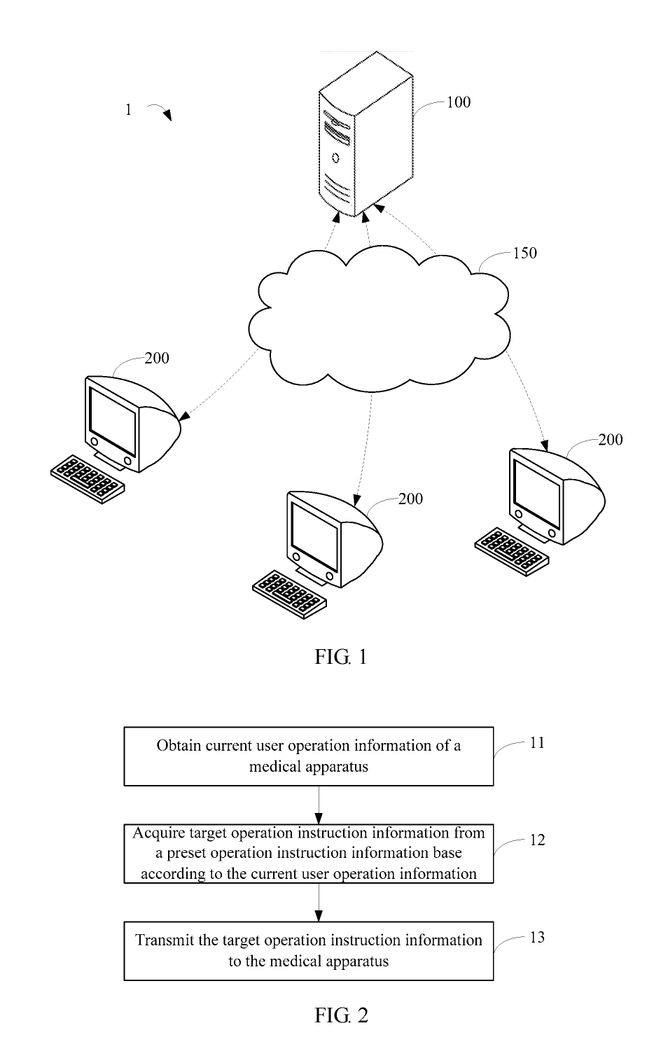

FIG. 1 illustrates a schematic diagram of an application scenario of providing operation instruction information of a medical apparatus, where methods of providing operation instruction information of the medical apparatus provided in accordance with the present disclosure may be applied in a cloud platform 1. As shown in FIG. 1, the cloud platform 1 includes a cloud server 100, medical apparatuses 200, and a network 150.

The network 150 can include a computer network, such as a local area network (LAN), a wide area network (WAN), the Internet, a wireless network, a wired network, a virtual private network, a cellular data network, or a combination of any of the foregoing, connecting any number of communication devices, computing devices, and/or server systems.

The cloud server 100 can include one or more computing devices and one or more machine-readable repositories or databases. The cloud server 100 can include a distributed computing system including multiple computers connected by one or more communications networks. Each computer can be implemented as one or more physical computers or as a virtual machine hosted on a physical computer. The distributed computing system can have an underlying infrastructure that configures, e.g., manages or allocates, computing resources, e.g., physical computers, storages, memories, and/or networks.

In some examples, the medical apparatuses 200 are apparatuses distributed among different medical institutions. Each medical institution can be provided with one or more medical apparatuses 200 having the same apparatus type. The medical apparatuses 200 can include medical imaging apparatuses such as Computed Tomography (CT) apparatuses, Positron Emission Tomography (PET) apparatuses, Magnetic Resonance Imaging (MRI) apparatuses or ultrasound imaging apparatuses. That is, the apparatus type can be CT, PET, MRI, ultrasound imaging, or any other type. The medical apparatuses 200 each can include any appropriate type of communication or computing device, e.g., a desktop computer, a personal computer, a notebook, a tablet computing device, a personal digital assistant (PDA), a network appliance, a smart mobile phone, an enhanced general packet radio service (EGPRS) mobile phone, a console, or any appropriate combination of any two or more of these computing devices or other computing devices.

Each of the medical apparatuses 200 can communicate data with the cloud server 100 through the network 150 in the cloud platform 1. The data uploaded by the medical apparatuses 200 to the cloud server 100 can include record data of sequence of operating multiple functions in a software operating system, operation steps of operating each function, and parameters set at each function during users operating the medical apparatuses 200. Each medical apparatus 200 can be a stand-alone data source and can transmit the record data to the cloud server 100 in real time or at a fixed time. In the specific implementation process, the medical apparatuses 200 and the cloud server 100 are independent of each other and connected with each other to implement the methods provided by the present disclosure together. In some cases, the methods are performed by the cloud server 100. In some cases, the methods are performed by one of the medical apparatuses 200.

FIG. 2 is a flow diagram of a process of providing operation instruction information of a medical apparatus in accordance with one or more examples of the present disclosure. The medical apparatus can be the medical apparatus 200 of FIG. 1. This process can be performed by a cloud server, e.g., the cloud server 100 of FIG. 1. The process can include steps 11-13.

In step 11, current user operation information of the medical apparatuses is obtained.

In an example, the medical apparatus includes an M-model CT device. During a series of operation processes such as turning on the CT device, using the CT device to scan a region of interest of an object, and turning off the CT device, the M-model CT device may generate the current user operation information in real time. The M-model CT device can transmit the current user operation information to the cloud server according to an actual operation of the CT device or an actual operation of a console of the CT device from a user.

The current user operation information can include apparatus identification and current operation information of the M-model CT device. According to different operation processes of the CT device from users, the current operation information can be divided into system setting operation information and scanning operation information. The system setting operation information refers to operation information generated during processes such as turning on, maintaining, and turning off a system, for example, a maintenance operation of a bulb tube, a maintenance operation of a cooling system, a cleaning of a memory, and the like. The scanning operation information refers to relevant operation information generated during acquiring scanned images, and can include: operation information generated when recording data of an object, setting a scanning protocol, and recording information such as operation steps when the user uses the CT device to scan the region of interest of the object; operation information of generating reports; operation information of scanning image reconstruction, such as air correction, batch processing and artifact processing of scanning images, and the like. The operation information can include information generated during the operation of the medical apparatus by a user, such as operation information of a particular step or several steps, operation information of turning on the medical apparatus, setting of the scanning protocol.

In step 12, target operation instruction information is acquired from an operation instruction information database according to the current user operation information.

The operation instruction information database can be generated by the cloud server. The cloud server can collect data including user operation record from medical apparatuses having the same apparatus type as the medical apparatus and/or operation instruction information manually set according to the experience. The medical apparatuses can be in different medical institutions. The cloud server can then perform mining and analysing the data to generate the operation instruction information database.

The operation instruction information database can include respective operation instruction information corresponding to each operation pattern of a medical apparatus of an apparatus type. One type of medical apparatuses may include multiple operating patterns, such as an on pattern, an off pattern, a data storing pattern, a data cleaning pattern, different scanning patterns corresponding to different scanning regions, different scanning patterns corresponding to different scanning manners, different scanning patterns corresponding to different types of objects, or scanning patterns co-determined by scanning regions, scanning manners, object information and other factors, and the like.

Each operation pattern can have corresponding operation instruction information. The operation instruction information may be taken as information of a preset operation pattern executing standard obtained by the cloud server based on factors such as hospital information included in the user operation record, output image quality, and operation results. The hospital information in the user operation record may include reference factors that can indicate a medical level, a region where the medical apparatus is located, a hospital qualification, and/or an overall technical level of radiologists.

In step 12, the cloud server can acquire the corresponding target operation instruction information from the operation instruction information database according to operation pattern information in the current user operation information.

In step 13, the target operation instruction information is transmitted to the medical apparatus to instruct the user to operate the medical apparatus.

In an example, the cloud server may directly transmit the target operation instruction information to the medical apparatus after matching and acquiring the target operation instruction information.

In another example, the cloud server may determine whether or not the current user operation information satisfies a preset condition after acquiring the target operation instruction information. When the current user operation information satisfies the preset condition, e.g., determined by the cloud server, the target operation instruction information is transmitted to the medical apparatus, which can at least include the following cases.

In a first case, the target operation instruction information is transmitted to the medical apparatus when a deviation between a current setting parameter in the current user operation information and a standard setting parameter in the target operation instruction information exceeds a predetermined range.

For example, the current user operation information transmitted by the M-model CT device is listed in Table 1.

TABLE 1
Current user operation information

| | | Scanning | |
|---|---|---|---|
| Scanning region | Scanning manner | voltage/current | Scanning time |
| Head | Helical scanning | 120 kV/400 mA | 10 seconds |

The target operation instruction information acquired by the cloud server after matching or searching the operation instruction information database according to a scanning region and a scanning pattern is as follows: the scanning voltage, the scanning current, and the scanning time set when a number of medical institutions (e.g., 5,000) use the helical scanning manner to scan the head are 100 kV, 200 mA, and 5 seconds respectively.

If the cloud server detects that the deviation between one or more parameters of the scanning voltage, the scanning current and the scanning time set by the M-model CT device and the corresponding setting parameters in the target instruction operation information exceeds the predetermined ranges under the condition of the same scanning region and the same scanning pattern (e.g., a scanning manner), the cloud server can transmit the target operation instruction information to the M-model CT device to make the M-model CT device generate prompt information according to the target operation instruction information to prompt the user to reset the parameters. Thus, the medical apparatus can acquire a scanned image which can be suitable as diagnosis basis, for example, in the case of reducing the radiation dose as much as possible.

In a second case, if the current user operation information includes help information, the target operation instruction information is transmitted to the medical apparatus.

For example, object history information included in the current user operation information can be: coughing is accompanied by slight pulmonary pain, and the current user operation information includes the help information for the user. The cloud server may acquire the target operation instruction information from the operation instruction information database according to the current user operation information. For example, the target operation instruction information may include 90% of hospitals selecting a lung scan, and may include step-by-step instruction operation information starting from selecting the scanning region for helping the user operate.

In a third case, a current apparatus state parameter of the medical apparatus is acquired according to the current user operation information. When the current state parameter of the medical apparatus exceeds a threshold, the target operation instruction information is transmitted to the medical apparatus.

For example, in the operation information of turning on the medical apparatus, the cloud server determines that the medical apparatus has not been air-corrected for more than 7 days according to the current turning-on operation information and latest apparatus maintenance record of the medical apparatus. The target operation instruction information on the air correction acquired from the preset operation instruction information database according to the turning-on pattern information of the CT device is that the maximum time interval for performing air correction is 7 days so as not to affect the detection image quality. The cloud server transmits the target instruction operation information to the medical apparatus to make the medical apparatus generate the prompt information according to the target instruction information to prompt the user to perform air correction on the medical apparatus, so as to ensure that the user may use the medical apparatus to acquire more accurate scanning data.

As another example, in the current operation information of turning off the medical apparatus, the cloud server inquires the operation instruction information database according to the current turning-off operation information, and determines the target operation instruction information corresponding to storage space management of the medical apparatus. For example, the target operation instruction information is that, in the data storage space management setting of the medical apparatus, 80% of the hospitals select to retain reconstructed image data of 300 objects and retain scanned raw data of 500 objects. When the current patient data retention setting of the medical apparatus exceeds a data retention threshold in the target operation instruction information, the cloud server can transmit the target operation instruction information to the medical apparatus to make the medical apparatus generate prompt information according to the target operation instruction information to prompt the user to clean up the storage space of the medical apparatus timely to ensure that sufficient memory space is reserved for the scanned raw data and the reconstructed image of the subsequent objects.

As a further example, the cloud server receives the current user operation information of starting the console, and the current user operation information includes parameters such as the exposure time of consumption components such as bulb tubes and upper slices. The corresponding target operation instruction information is acquired from the preset operation instruction information database according to the parameters. The target operation instruction information is transmitted to the medical apparatus when the parameters such as the exposure time of the consumption components such as bulb tubes and upper slices in the current user operation information exceed a corresponding threshold in the target operation instruction information to make the medical apparatus generate the prompt information according to the target operation instruction information to prompt the user to timely maintain the corresponding parts in the medical apparatus.

In some implementations, the cloud server generates one or more machine instructions based on the target operation instruction information to control the operation of the medical apparatus. The cloud server can generate the machine instructions in response to at least one of the above three cases, that is, when a deviation between a current setting parameter in the current user operation information and a standard setting parameter in the target operation instruction information exceeds a predetermined range, when the current user operation information comprises help information, or when a current apparatus state parameter in the current user operation information exceeds a threshold in the target operation instruction information. The cloud server can transmit the machine instructions to the medical apparatus and the medical apparatus can be controlled, e.g., automatically, by the machine instructions to run.

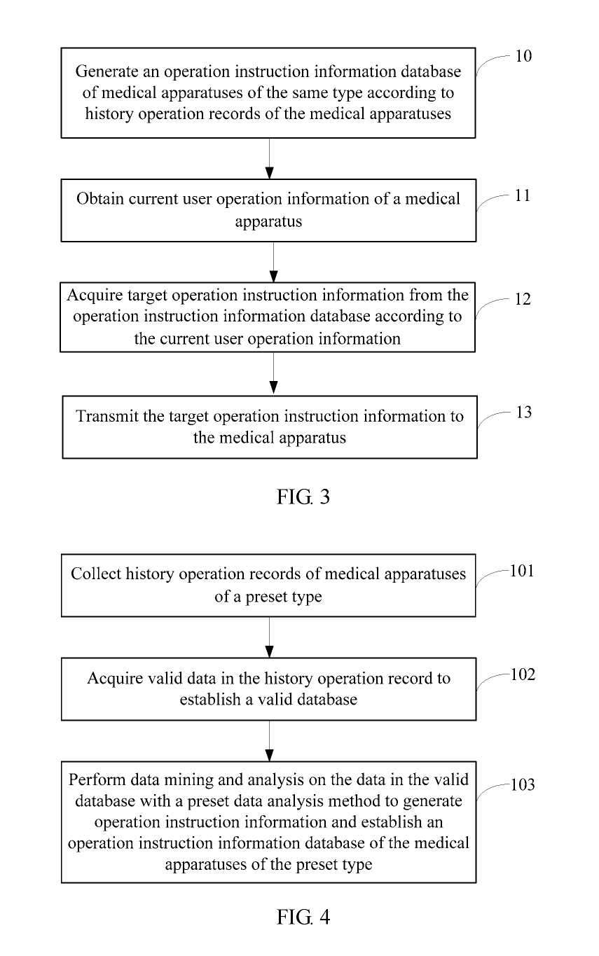

FIG. 3 is a flow diagram of a process of providing operation instruction information of the medical apparatus in accordance with one or more another examples. Compared to the process shown in FIG. 2, the process can further include step 10 prior to the step 11.

In step 10, an operation instruction information database of the medical apparatuses of the same type is generated according to history operation records of the medical apparatuses of the same type in different medical institutions. Each medical apparatus can have a respective history operation record.

Specifically, FIG. 4 is a flow diagram of a process of generating the operation instruction information database of the medical apparatuses of the same type in step 10 of the process in FIG. 3. On the basis of the process shown in FIG. 3, generating the operation instruction information database in step 10 may include steps 101-103.

In step 101, the history operation records of medical apparatuses of an apparatus type are collected. The apparatus type can be preset or predetermined by the cloud server. In some examples, the cloud server can determine the type of the medical apparatus and then generate the operation instruction information database of the medical apparatuses having the same type as the medical apparatus.

As illustrated in FIG. 1, the cloud server 100 may receive the history operation record uploaded directly or indirectly by the medical apparatuses of the same type distributed in different countries and/or regions through the cloud platform 1. The medical apparatuses of the same apparatus type can be the medical apparatuses having the same model, for example, the M-model CT devices from the same apparatus manufacturer.

In an example, the history operation record transmitted by each medical apparatus may be uploaded to the cloud server in real time in a form of a data flow. In another example, the medical apparatus may temporarily store the generated history operation record in a local server or a server of the medical institution to which the medical apparatus belongs, and then the history operation record generated by the medical apparatus is periodically transmitted to the cloud server by the server of the medical apparatus or the medical institution.

The history operation record uploaded by each medical apparatus can include the apparatus identification of the medical apparatus and an original operation record, and can also include basic information of the medical institution to which the medical apparatus belongs, a country and/or region where the medical apparatus is located, qualification of the medical institution, an overall technical level of medical workers in the department where the medical apparatus is provided, and other information.

In step 102, valid data in the history operation records is acquired, and a valid database is established.

The history operation records uploaded to the cloud server by the medical apparatuses may include incomplete operation data which are invalid data with respect to the operation instruction information of an operating pattern. The cloud server can first remove invalid data from the history operation records, re-shape data from different data sources into system-defined user characteristic data model, and establish the valid database.

In an example, the cloud server may be communicatively connected to a large number of medical apparatuses located in different parts of the world. The cloud server can receive a large amount of data flows at all times. The data flow can refer to input data arriving at the cloud server at a very high speed. In an example, the cloud server may use a real-time computing system, e.g., Twitter Storm, to perform flow calculation on the data flow, extract the valid data from the history operation records, and establish a valid database to form a centralized large distributed database. The distributed database may include two main branches: scanning operation data and system maintenance operation data, or may include a main branch according to geographical information of the medical apparatus.

In an example, the valid data of the medical apparatuses of the same apparatus type can include the apparatus identification, the hospital information, and the operation record. The hospital information may include information such as the country and/or region where the medical apparatus is located, the hospital qualification, and the technical level of radiologists. The operation record may include an apparatus maintenance operation record and a scanning operation record. In an example, the operation record is different from the current operation information in step 11, and the operation record can refer to the record information generated after a user completes an operation pattern, and can include operation process information and operation result information. That is, an operation record can completely record operation process and result of an operation pattern. Taking image reconstruction as an example, an operation record of image reconstruction can include information such as operation steps of a user during image reconstruction, parameter setting of each step, and a result of image reconstruction.

In an example, the apparatus maintenance operation record refers to record information generated after the operations (e.g., turning on, maintenance, and turning off) are performed on the medical apparatus. The scanning operation record refers to record information generated after performing the related operation in the process of acquiring the scanned image.

In step 103, data in the valid database are mined and analyzed by using a data analysis method or algorithm to generate operation instruction information and establish an operation instruction information database of the medical apparatuses of the same apparatus type.

In an example, the data analysis method or algorithm may be utilized to perform data mining and analysis on the valid database of one kind of operation data to acquire the operation instruction information corresponding to each operation pattern. The data analysis method can include, but is not limited to, a correlation analysis method, a sequence pattern analysis method, a classification analysis method, and the like.

In the following, the process of data mining in the above data analysis methods can be described in combination with examples.

### Example I

### Correlation Analysis

The correlation analysis is configured to find correlation or relevance existing in a large number of data sets so as to describe regularity and pattern that some properties in a thing appear at the same time. A particular regularity existing between values of two or more variables is referred to be the correlation. In an example, the variables of “degree of use” and “degree of reputation” may be introduced to measure the correlation of the data sets, and the variables such as “degree of interest” may be increased so that the operation instruction information mined by the correlation analysis method is more accurate.

For example, the correlation analysis method can be utilized to perform data mining on the valid database of the scanning operation to acquire one piece of operation instruction information. The operation instruction information can be that, during a helical scan of a head, the scanning voltage parameter and the scanning current parameter used by 95% of the Grade III Class A hospitals are 100 kV and 200 mA respectively, where 95% refers to the degree of use and Grade III Class A refers to the degree of reputation.

As another example, the correlation analysis method is utilized to perform data mining on the valid database of the system maintenance operation to acquire one piece of operation instruction information. The operation instruction information can be that, in the management parameter setting of the storage space of the medical apparatus, 80% of the hospitals select to temporarily retain the reconstruction image data of 300 objects and temporarily retain scanned raw data of 500 objects.

### Example II

### Sequence Pattern Mining

Sequence pattern mining refers to a pattern in which there is a higher frequency of occurrence in mining relative time or other patterns.

The sequence pattern analysis is that an anteroposterior position of each item in the pattern is one of the pattern recognition features, that is, the items in the pattern are sequential. Therefore, when the sequence pattern is looked for, a measuring manner “time” for determining the order of the items is provided. User's operations arrange in sequence in a one-dimensional direction according to the measuring manner “time”, and the received data are analyzed through the sequence pattern analysis to develop information, instruct and prompt the user to operate.

The above items may be a set of operation steps corresponding to a scanning pattern, e.g., a whole set of operation steps corresponding to a lung scan pattern or a head scan pattern. The item may be understood as one of the steps in the above whole set of operation steps.

For example, the sequence pattern analysis method is utilized to perform data mining on the valid database of the scanning operation to acquire one piece of operation instruction information. The operation instruction information can be that, in the operation step of registering the patient information, 90% of the hospitals select low-dose voltage and current parameters which may be 80 kV, 30 mA in the next operation of selecting the scanning dose for patients when an input age of the patient is younger than 10 years.

In a practical application, when the medical apparatus detects the current operation information of the user that the operation of inputting the patient information is currently performed and the input age of the patient in the operation is 8 years old, the cloud server acquires the next target operation instruction information from the operation instruction information database according to the current user operation information, and transmits the information to the medical apparatus for information prompting. For example, what is displayed on the display screen of the medical apparatus is that the scanning dose setting operation is performed next, and for patients younger than 10 years old, 90% of the hospitals select small-dose voltage and current parameters which are 80 kV, 30 mA, so as to prompt the user to set the scanning dose operation in the next step and prompt the user that the voltage parameter may be set to 80 kV and the current parameter may be set to 30 mA.

### Example III

### Classification Analysis

The classification analysis provides a record set and a set of tags. The tag is a set of categories having different characteristics. First, each record is given a tag, that is, the records in the record set are classified using the tag. Then, each category of records is analyzed according to the classification, the characteristics of the record are described, and new records may be classified using these characteristics. For example, the system maintenance operation database includes evaluation information about the maintenance status of the medical apparatus. For example, the above evaluation information is classified into three categories which are excellent, good, and general.

The valid database of the system maintenance operation is analyzed through the classification analysis method to acquire the following operation instruction information: excellent hospitals regularly perform scheduled tasks, maintain the medical apparatus on time, and follow the instruction manual to operate the medical apparatus. That is, the operation instruction information about usage habits of the medical apparatus is acquired. The cloud server may use the operation instruction information to instruct the operators of other hospitals to operate the medical apparatus so that the medical apparatus of other hospitals may acquire a better use effect, thereby enhancing the medical technology level of the hospital.

In summary, the operation instruction information corresponding to each operation pattern can be acquired and the operation instruction information database of the cloud server can be generated by performing data mining on the valid database of the system maintenance operation or the scanning operation in the relevant data mining and analysis method.

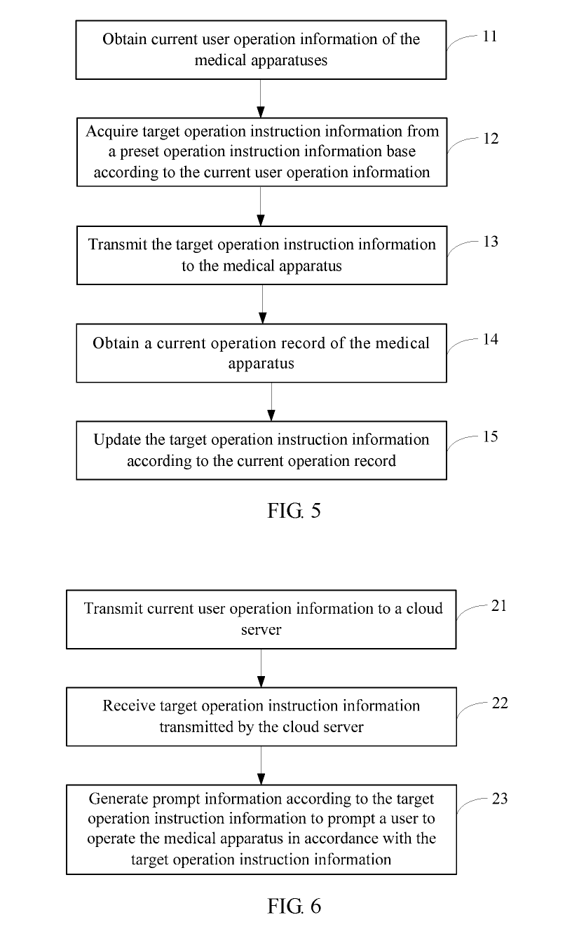

FIG. 5 is a flow diagram of a process of providing operation instruction information of a medical apparatus in accordance with one or more another examples. On the basis of the examples shown in FIG. 2, the process in FIG. 5 can further include steps 14 and 15.

In step 14, a current operation record of the medical apparatus is obtained.

In an example, after the medical apparatus operates according to the target operation instruction information, the current operation record is generated according to an operation result in combination with the current user operation information. The current operation record can be uploaded to the cloud server.

In step 15, the target operation instruction information is updated according to the current operation record.

The cloud server can extract valid data of the current operation record according to an operation record processing process of a user, update the valid database, and update the operation information corresponding to the operation pattern according to the updated valid database.

It may be seen that the cloud server may further continuously acquire the valid data in the user operation data flow and increase the data volume of the valid database through the method provided in the present disclosure, so that the cloud platform may mine and analyze more accurate operation instruction information from the valid database. That is, when permitted by the storage capacity of the cloud server, the subsequently acquired user operation record may also be utilized to continuously correct the acquired operation instruction information, so that the mined and analyzed operation instruction information is more accurate, which can be then used to instruct the user to use the medical apparatus to reduce the radiation dose of the apparatus to objects as much as possible in the case of acquiring the diagnosis-demanded image, thereby improving the medical level. Also, the cloud server can instruct users to use or maintain the medical apparatus more scientifically and rationally and extend a service life of the medical apparatus, thereby reducing the cost of medical care.

Accordingly, methods of obtaining operation instruction information of a medical apparatus are provided in the present disclosure. FIG. 6 is a flow diagram of a process of obtaining operation instruction information of a medical apparatus in accordance with one or more example. The process can include steps 21-23. The medical apparatus can be the medical apparatus 200 of FIG. 1.

In step 21, current user operation information is transmitted to a cloud server. The cloud server can be the cloud server 100 of FIG. 1. The medical apparatus can generate the current user operation information by generating at least one of system setting operation information generated during processes of the medical apparatus, or scanning operation information generated during acquiring scanned images by the medical apparatus.

Also taking the M-model CT device as an example, the M-model CT device can transmit the current user operation information generated according to the operation information of a user to the cloud server in real time. The current user operation information may include operation information of turning on the apparatus, operation information of turning off the apparatus, operation information of scanning an object's region of interest, and the like.

In step 22, target operation instruction information transmitted by the cloud server is received, which is acquired from an operation instruction information database according to the current user operation information by the cloud server.

The operation instruction information database may be generated by the cloud server performing data mining and analysis according to user operation records transmitted by medical apparatuses having the same apparatus type as the medical apparatus. The medical apparatuses can be in different medical institutions.

In step 23, prompt information is generated according to the target operation instruction information to prompt a user to operate the medical apparatus in accordance with the target operation instruction information.

In an example, the M-model CT device may generate the prompt information according to the target operation instruction information after receiving the target operation instruction information.

In an example, the case where the prompt information is generated based on the target operation instruction information may include at least one of three cases listed below.

In a first case, the prompt information is generated according to the target operation instruction information when a deviation between a current setting parameter in the current user operation information and a standard setting parameter in the target operation instruction information exceeds a predetermined range.

In a second case, the prompt information is generated according to the target operation instruction information when the current user operation information includes help information.

In third case, the prompt information is generated according to the target operation instruction information when a current apparatus state parameter in the current user operation information exceeds a threshold in the target operation instruction information.

In an example, the medical apparatus may display, e.g., on a display, the prompt information in the form of one or more of voice prompt, text display, multimedia animation, vibration and the like or any combinations thereof, thereby prompting the user to operate the medical apparatus in accordance with the target operation instruction information.

In some implementations, the medical apparatus adjusts one or more settings based on the target operation instruction information to operate the medical apparatus. In some cases, the medical apparatus automatically adjusts the settings in response to receiving the target operation instruction information. In some cases, the medical apparatus receives one or more machine instructions generated based on the target operation instruction information and automatically adjust the settings based on the one or more machine instructions. In some cases, the medical apparatus displays the machine instructions and/or the target operation instruction information, e.g., on a display of the machine apparatus, to the user. The user may indicate to operate the medical apparatus based on the machine instructions and/or the target operation instruction information. In response to receiving the indication to operate the medical apparatus based on the machine instructions and/or the target operation instruction information, the medical apparatus can adjust, e.g., automatically, the settings based on the machine instructions and/or the target operation instruction information.

In some implementations, the medical apparatus adjusts the one or more settings of the medical apparatus according to at least one of the above three cases, that is, when a deviation between a current setting parameter in the current user operation information and a standard setting parameter in the target operation instruction information exceeds a predetermined range, when the current user operation information comprises help information, or when a current apparatus state parameter in the current user operation information exceeds a threshold in the target operation instruction information.

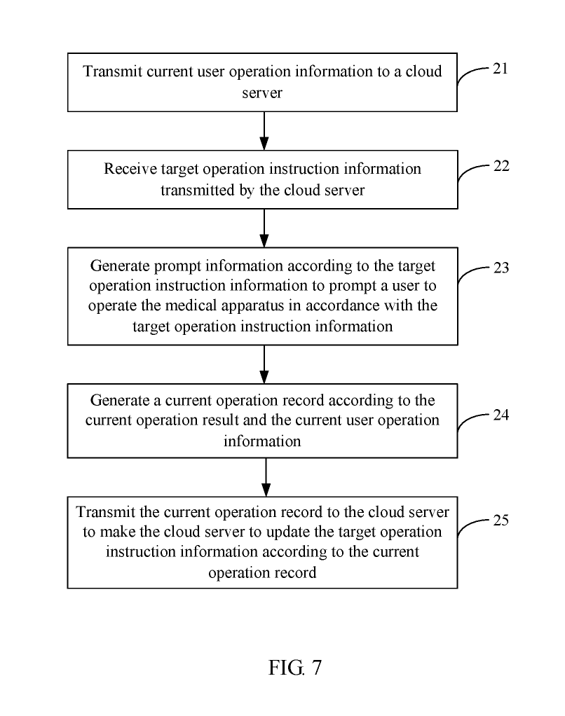

FIG. 7 is a flow diagram of a process of obtaining operation instruction information of the medical apparatus in accordance with one or more another examples. On the basis of the process in FIG. 6, the process in FIG. 7 can further include steps 24 and 25.

In step 24, the current operation record is generated according to a current operation result and a new current user operation information. The new current user operation information can be based on the target operation instruction information received from the cloud server.

In step 25, the current operation record is transmitted to the cloud server to make the cloud server update the target operation instruction information according to the current operation record.

Each of the foregoing method embodiments has been described as a combination of a series of actions for the sake of brevity, but those skilled in the art will recognize that the application is not limited by the described sequence of actions since some steps may be performed in other orders or simultaneously in accordance with the application.

Secondly, those skilled in the art will also appreciate that all the embodiments described in the specification are optional embodiments and that the actions and modules involved are not necessarily required in the application.

Correspondingly to the methods of providing operation instruction information of the medical apparatus, the present disclosure also provides a device for providing operation instruction information of the medical apparatus, which can be provided in the cloud server 100 of the cloud platform 1 shown in FIG. 1. The device can include one or more processors and a non-transitory computer readable storage medium in data communication with the one or more processors and storing instructions executable by the one or more processors and upon such execution cause the one or more processors to perform the methods of providing the operation instruction information of the medical apparatus. The medical apparatus communicatively connected with the cloud server 100 includes multiple medical apparatuses 200 of the same type.

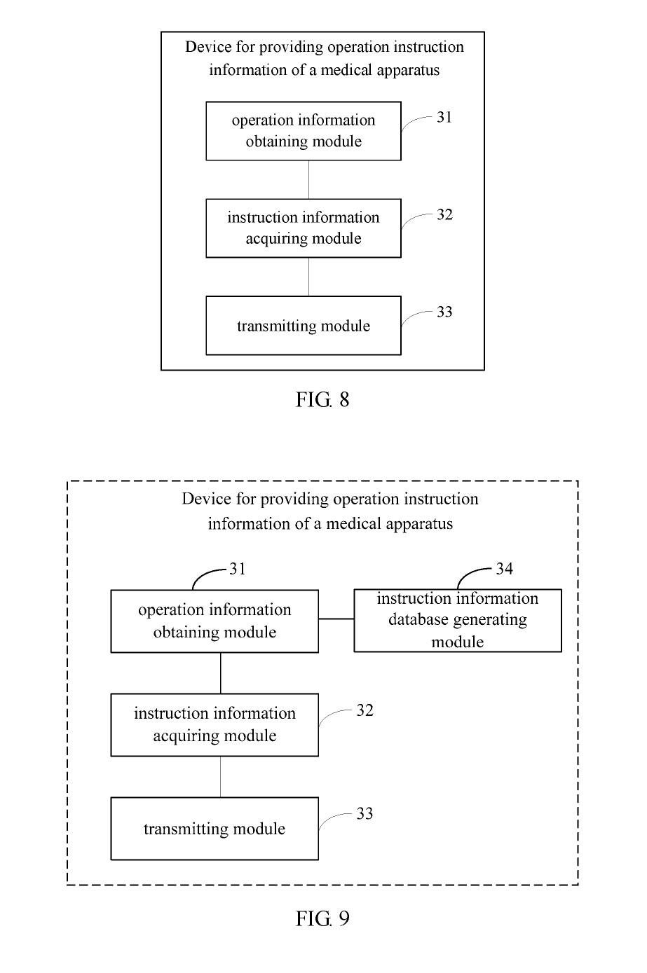

FIG. 8 illustrates a block diagram of the device for providing operation instruction information of the medical apparatus in accordance with one or more examples. Referring to FIG. 8, the device includes an operation information obtaining module 31, an instruction information acquiring module 32 and a transmitting module 33. The modules 31-33 can be implemented in the one or more processors and the non-transitory computer readable storage medium in the device.

The operation information obtaining module 31 is configured to obtain current user operation information of the medical apparatuses.

The instruction information acquiring module 32 is configured to acquire target operation instruction information from a preset operation instruction information database according to the current user operation information; and

The transmitting module 33 is configured to transmit the target operation instruction information to the medical apparatuses.

FIG. 9 illustrates a block diagram of the device for providing operation instruction information of the medical apparatus in accordance with one or more another examples. Referring to FIG. 9, on the basis of the device in FIG. 8, the device in FIG. 9 may further include an instruction information database generating module 34.

The instruction information database acquiring module 34 is configured to generate an operation instruction information database of the medical apparatuses of the same type according to the history operation record of the medical apparatuses of the same type in different medical institutions.

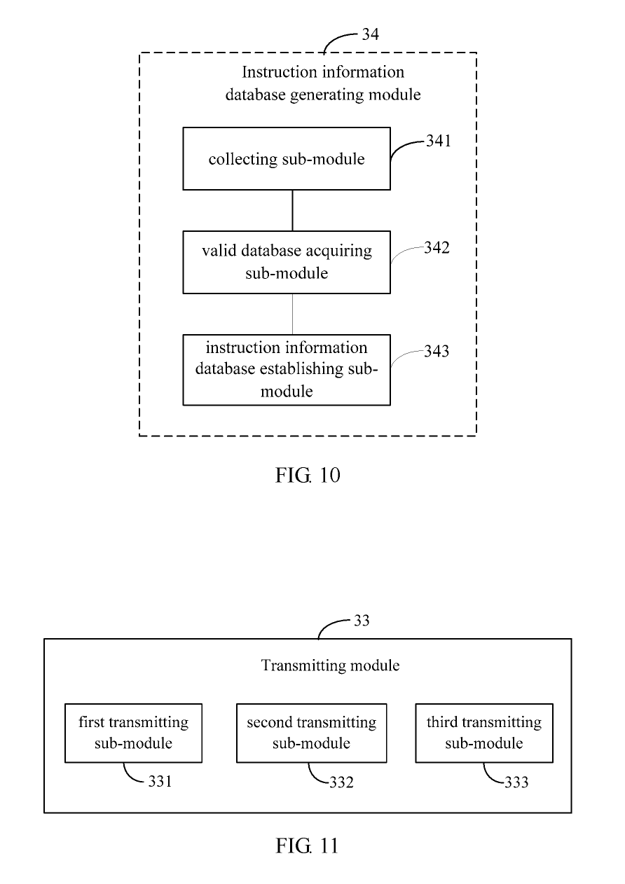

FIG. 10 illustrates a block diagram of the instruction information database generating module 34 of the device in FIG. 9 in accordance with one or more examples. Referring to FIG. 10, on the basis of the device in FIG. 9, the instruction information database generating module 34 may include a collecting sub-module 341, a valid data acquiring sub-module 342 and an instruction information database establishing sub-module 343.

The collecting sub-module 341 is configured to collect the history operation record of medical apparatuses having a same apparatus type. The apparatus type can be preset.

The valid data acquiring sub-module 342 is configured to acquire valid data in the history operation record and establish a valid database.

The instruction information database establishing sub-module 343 is configured to perform data mining and analysis on the data in the valid database with a data analysis method or algorithm to generate operation instruction information, and establish an operation instruction information database of the medical apparatuses of the apparatus type. The data analysis method can be preset, and can include at least one of a correlation analysis method, a sequence pattern analysis method, and a classification analysis method.

FIG. 11 illustrates a block diagram of the transmitting module 33 of the device in FIG. 8 in accordance with one or more examples. Referring to FIG. 11, on the basis of the device shown in FIG. 8, the transmitting module 33 includes at least one of a first transmitting sub-module 331, a second transmitting sub-module 332 and a third transmitting sub-module 333.

The first transmitting sub-module 331 is configured to transmit the target operation instruction information to the medical apparatuses when a deviation between a current setting parameter in the current user operation information and a standard setting parameter in the target operation instruction information exceeds a predetermined range.

The second transmitting sub-module 332 is configured to transmit the target operation instruction information to the medical apparatuses when the current user operation information includes help information.

The third transmitting sub-module 333 is configured to transmit the target operation instruction information to the medical apparatuses when a current apparatus state parameter in the current user operation information exceeds a threshold in the target operation instruction information.

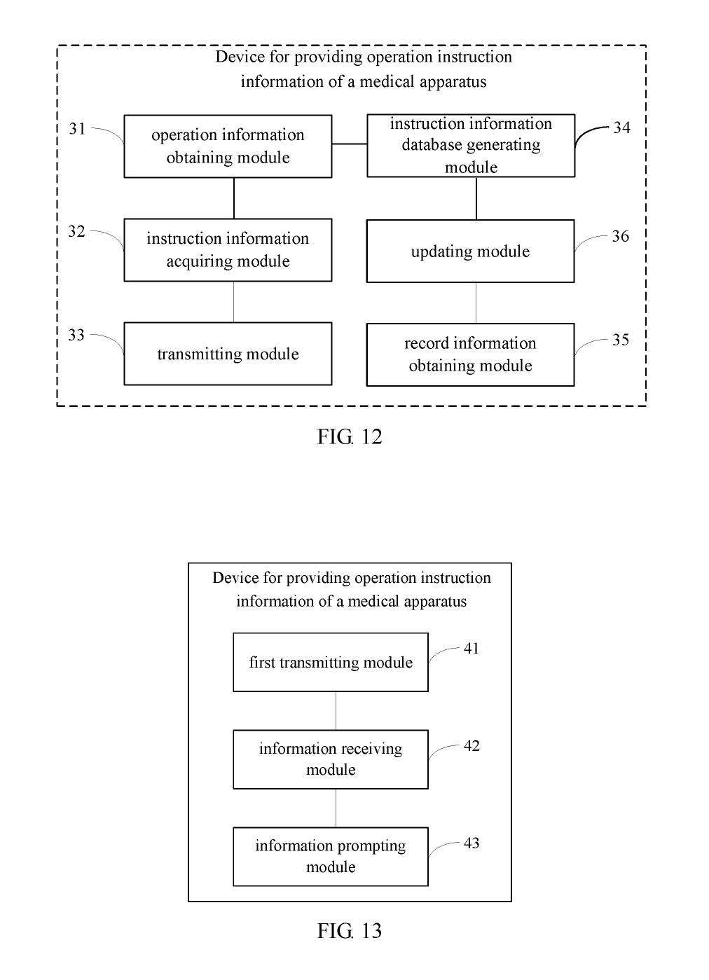

FIG. 12 illustrates a block diagram of the device for providing operation instruction information of the medical apparatus in accordance with one or more another examples. Referring to FIG. 12, on the basis of the examples shown in FIG. 9, the device in FIG. 12 may further include a record obtaining module 35 and an updating module 36.

The record obtaining module 35 is configured to obtain the current operating record of the medical apparatuses.

The updating module 36 is configured to update the target operation instruction information according to the current operation record.

Accordingly, a device for obtaining operation instruction information of the medical apparatus may be provided in the medical apparatuses 200 of the cloud platform shown in FIG. 1, more particularly in control apparatuses of the medical apparatuses. The device can include one or more processors and a non-transitory computer readable storage medium in data communication with the one or more processors and storing instructions executable by the one or more processors and upon such execution cause the one or more processors to perform the methods of obtaining the operation instruction information of the medical apparatus. The medical apparatus may be a medical imaging apparatus such as a computed tomography apparatus (CT) apparatus, a positron emission tomography (PET) apparatus, a magnetic resonance imaging apparatus (MRI) apparatus, and an ultrasonic imaging apparatus, and the like.

FIG. 13 illustrates a block diagram of the device for obtaining operation instruction information of the medical apparatus in accordance with one or more another examples. Referring to FIG. 13, the device may include a first transmitting module 41, an information receiving module 42 and an information prompting module 43. The modules 41-43 can be implemented in the one or more processors and the non-transitory computer readable storage medium in the device.

The first transmitting module 41 is configured to transmit the current user operation information to the cloud server.

The information receiving module 42 is configured to receive the target operation instruction information transmitted from the cloud server, which is acquired from the preset operation instruction information database by the cloud server according to the current user operation information.

The information prompting module 43 is configured to generate the prompt information databased on the target operation instruction information to prompt the user to operate the medical apparatus in accordance with the target operation instruction information. The information prompting module 43 may utilize at least one of text display, voice playback, multimedia animation and vibration to prompt the user to operate the medical apparatus in accordance with the target instruction information.

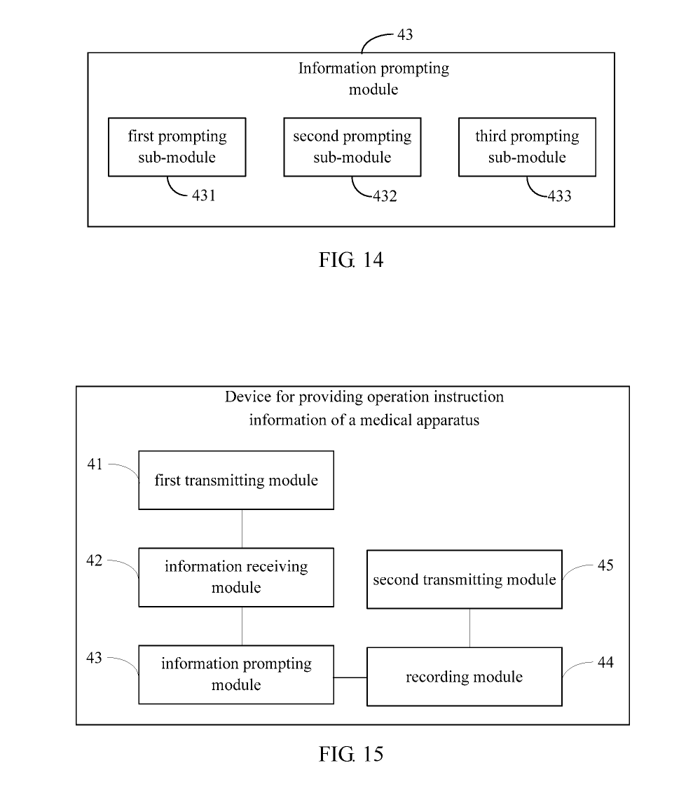

FIG. 14 illustrates a block diagram of the information prompting module 43 of the device in FIG. 13 in accordance with one or more examples. Referring to FIG. 14, on the basis of the device shown in FIG. 13, the information prompting module 43 in FIG. 14 may include at least one of a first prompting sub-module 431, a second prompting sub-module 432 and a third prompting sub-module 433.

The first prompting sub-module 431 is configured to generate the prompt information according to the target operation instruction information when a deviation between a current setting parameter in the current user operation information and a standard setting parameter in the target operation instruction information exceeds a predetermined range.

The second prompting sub-module 432 is configured to generate the prompt information according to the target operation instruction information when the current user operation information includes help information.

The third prompting sub-module 433 is configured to generate the prompt information according to the target operation instruction information when a current apparatus state parameter in the current user operation information exceeds a threshold in the target operation instruction information.

FIG. 15 illustrates a block diagram of the device for obtaining operation instruction information of the medical apparatus in accordance with one or more another embodiment. Referring to FIG. 15, on the basis of the device shown in FIG. 13, the device in FIG. 15 may further include a recording module 44 and a second transmitting module 45.

The recording module 44 is configured to generate the current operation record in accordance with the current operation result and the current user operation information.

The second transmitting module 45 is configured to transmit the current operation record to the cloud server to make the cloud server update the target operation instruction information in accordance with the current operation record.

The detailed implementation processes of the functions and effects of the respective modules in the device are seen in the implementation processes of the corresponding blocks in the above method, and will not be described here again.

For a device embodiment, since it corresponds substantially to a method embodiment, the relevant aspects are described in part in the description of the method embodiment. The device embodiment described above are merely exemplary in which the units illustrated as separate components may or may not be physically separated and the components displayed as units may or may not be physical units, this is to say, they may be located in one place, or they may be distributed over a plurality of network units. Some or all of the modules may be selected according to actual needs to realize the purpose of the solution of the invention. Those skilled in the art may understand and act without giving creative work.

The method of providing operation instruction information of the medical apparatus may be executed by an information processing device in the cloud server or the medical apparatus. The device can include one or more processors and a non-transitory computer-readable storage medium having instructions stored thereon which, when executed by the one or more processors, cause the one or more processors to perform the methods of providing operation instruction information of the medical apparatus.

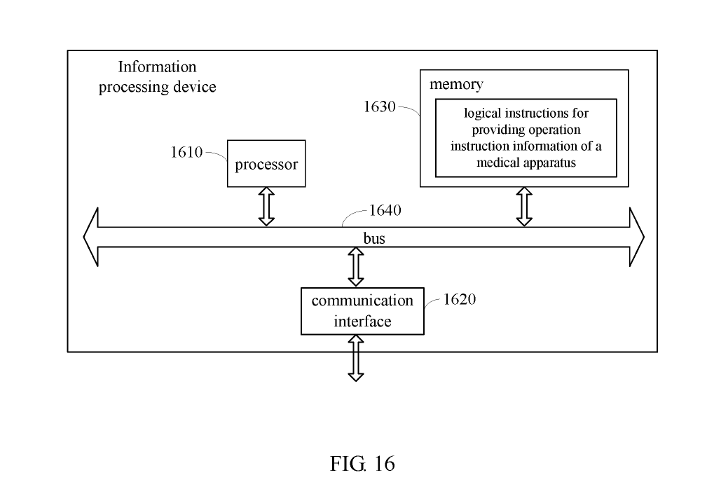

FIG. 16 illustrates a structure of the information processing device in accordance with one or more examples. Referring to FIG. 16, the information processing device may include a processing component 1610, a communication interface 1620, a memory 1630, and a bus 1640. The processing component 1610, the communication interface 1620, and the memory 1630 communicate with each other via the bus 1640.

The memory 1630 may store therein a logical instruction for providing operation instruction information of the medical apparatus. The memory 1630 may be, for example, a non-volatile memory. The processing component 1610 may invoke and perform the logic instruction for providing operation instruction information of the medical apparatus in the memory 1630 to perform the methods of providing the operation instruction information of the medical apparatus. For example, the logic instruction for providing the operation instruction information of the medical apparatus may be a program corresponding to a part of functions of the control software of the medical image acquiring system. When the processor executes the instruction, the control apparatus may display the function interface corresponding to the instruction on the display interface correspondingly.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures and descriptions do not necessarily require the particular order shown, or sequential order, to achieve desirable results. In certain implementations, multitasking and parallel processing can be advantageous.

It is to be understood that the invention is not limited to the precise structure already described above and illustrated in the drawings, and that various modifications and changes may be made without departing from the scope thereof. The scope of the invention is limited only by the appended claims.

1. A method of providing operation instruction information of a medical apparatus by a cloud server configured to communicate with a plurality of medical apparatuses having a same apparatus type as the medical apparatus, the method comprising:
obtaining, by one or more computing devices at the cloud server, current user operation information of the medical apparatus;
acquiring, by the one or more computing devices at the cloud server and based on the obtained current user operation information, target operation instruction information from an operation instruction information database associated with the plurality of medical apparatuses; and
transmitting, from the one or more computing devices at the cloud server, the target operation instruction information to the medical apparatus.

2. The method of claim 1, further comprising:
establishing, by the one or more computing devices at the cloud server, the operation instruction information database based on history operation records of the plurality of medical apparatuses of the same apparatus type in different medical institutions.

3. The method of claim 2, wherein establishing the operation instruction information database comprises:
collecting the history operation records of the plurality of medical apparatuses of the same apparatus type;
acquiring valid data in the collected history operation records to establish a valid database; and
performing data mining and analysis on data in the valid database to establish the operation instruction information database for the plurality of medical apparatuses of the same apparatus type.

4. The method of claim 3, wherein performing data mining and analysis on data in the valid database comprises:
performing at least one of correlation analysis, sequence pattern analysis, or classification analysis on the data in the valid database.

5. The method of claim 1, wherein acquiring target operation instruction information from an operation instruction information database comprises:
searching the target operation instruction information in the operation instruction information database based on an operation pattern of the medical apparatus, the operation instruction information database including respective operation instruction information associated with operation patterns of the medical apparatus.

6. The method of claim 1, wherein transmitting the target operation instruction information to the medical apparatus comprises at least one of:
transmitting the target operation instruction information to the medical apparatus when a deviation between a current setting parameter in the current user operation information and a standard setting parameter in the target operation instruction information exceeds a predetermined range;
transmitting the target operation instruction information to the medical apparatus when the current user operation information comprises help information; or
transmitting the target operation instruction information to the medical apparatus when a current apparatus state parameter in the current user operation information exceeds a threshold in the target operation instruction information.

7. The method of claim 1, further comprising:
obtaining, by the one or more computing devices at the cloud server, a current operation record of the medical apparatus; and
updating, by the one or more computing devices at the cloud server, the target operation instruction information according to the obtained current operation record of the medical apparatus.

8. The method of claim 1, wherein the current user operation information of the medical apparatus comprises at least one of:
system setting operation information for processes of the medical apparatus, or
scanning operation information for acquiring scanned images by the medical apparatus.

9. The method of claim 1, wherein the medical apparatus comprises a computed tomography apparatus, a positron emission tomography apparatus, a magnetic resonance imaging apparatus, or an ultrasound imaging apparatus.

10. A method performed by a medical apparatus, comprising:
transmitting current user operation information of the medical apparatus to a cloud server configured to communicate with a plurality of medical apparatuses having a same apparatus type as the medical apparatus;
receiving target operation instruction information from the cloud server, the target operation instruction information being acquired from an operation instruction information database according to the current user operation information by the cloud server, the operation instruction information database being associated with the plurality of medical apparatuses; and
generating prompt information according to the target operation instruction information to prompt a user to operate the medical apparatus in accordance with the target operation instruction information.

11. The method of claim 10, wherein generating prompt information according to the target operation instruction information comprises at least one of:
generating the prompt information according to the target operation instruction information when a deviation between a current setting parameter in the current user operation information and a standard setting parameter in the target operation instruction information exceeds a predetermined range;
generating the prompt information according to the target operation instruction information when the current user operation information comprises help information; or
generating the prompt information according to the target operation instruction information when a current apparatus state parameter in the current user operation information exceeds a threshold in the target operation instruction information.

12. The method of claim 10, further comprising:
generating a current operation record according to a current operation result and a new current user operation information based on the target operation instruction information; and
transmitting the generated current operation record to the cloud server to allow the cloud server to update the target operation instruction information for the medical apparatus according to the current operation record.

13. The method of claim 10, wherein generating prompt information according to the target operation instruction information to prompt a user to operate the medical apparatus comprises:
displaying, on a display of the medical apparatus, the generated prompt information to the user for operating the medical apparatus in accordance with the target operation instruction information.

14. The method of claim 10, further comprising:
adjusting, by the medical apparatus and based on the target operation instruction information, one or more settings of the medical apparatus to operate the medical apparatus.

15. The method of claim 14, further comprising:
controlling the medical apparatus to scan a region of interest of an object based on the adjusted settings of the medical apparatus.

16. The method of claim 10, further comprising generating the current user operation information of the medical apparatus.

17. The method of claim 16, wherein generating the current user operation information comprises at least one of:
generating system setting operation information during processes of the medical apparatus, or
generating scanning operation information during acquiring scanned images by the medical apparatus.

18. The method of claim 10, wherein the operation instruction information database includes respective target operation instruction information associated with operation patterns of the medical apparatus.

19. The method of claim 10, wherein the medical apparatus comprises a computed tomography apparatus, a positron emission tomography apparatus, a magnetic resonance imaging apparatus, or an ultrasound imaging apparatus.

20. A system, comprising:
one or more processors; and
a non-transitory computer readable storage medium in data communication with the one or more processors and storing instructions executable by the one or more processors and upon such execution cause the one or more processors to perform a method of providing operation instruction information of a medical apparatus, the method comprising:
obtaining current user operation information of the medical apparatus;
acquiring, based on the obtained current user operation information, target operation instruction information from an operation instruction information database associated with a plurality of medical apparatuses having a same apparatus type as the medical apparatus; and
transmitting the target operation instruction information to the medical apparatus.
